(19) United States
(12) Patent Application Publication
(10) Pub. No.: US 2010/0202885 A1
(43) Pub. Date: Aug. 12, 2010

(54) Epicyclic Gear Stage For A Wind Turbine Gearbox, A Wind Turbine Gearbox And A Wind Turbine

(76) Inventors: Jens DEMTRÖDER, Ronde (DK); Abdelhalim MOSTAFI, Bochum (DE)

Correspondence Address: ST. ONGE STEWARD JOHNSTON & REENS, LLC, 986 BEDFORD STREET, STAMFORD, CT, 06905-5619, US

(21) Appl. No.: 12/765,660

(22) Filed: Apr. 22, 2010

Related U.S. Application Data
(63) Continuation of application No. PCT/DK2008/000369, filed on Oct. 21, 2008.
(60) Provisional application No. 61/015,799, filed on Dec. 21, 2007.

(30) Foreign Application Priority Data
Oct. 22, 2007 (DK) PA 2007 01514
Dec. 21, 2007 (DK) PA 2007 01856

(51) Int. Cl. F03D 11/02; F16H 57/08

(52) U.S. Cl. 416/170 R; 475/331

(57) ABSTRACT

An epicyclic gear stage for a wind turbine gearbox including a sun gear, at least two planet gears, engaged with the sun gear, an annulus gear, a first planet carrier flange connected to one side of at least two of the planet gears, and a second planet carrier flange connected to the other side of least two of the planet gears. Torque from the wind turbine rotor is transferred via a torque transfer part connected to at least one of the first and second planet carrier flanges at one or more torque transferring zones and the one or more torque transferring zones are located between a first and a second plane, the planes being substantially perpendicular to an axis of rotation of the sun gear.

### CROSS-REFERENCE TO RELATED APPLICATIONS

The present application is a continuation of pending International patent application PCT/DK2008/000369 filed on Oct. 21, 2008 which designates the United States and claims priority from Danish patent applications PA 2007 01514, filed Oct. 22, 2007, PA 2007 01856 filed on Dec. 21, 2007, and U.S. Provisional Patent Application Ser. No. 61/015,799 filed on Dec. 21, 2007. The content of all prior applications is incorporated herein by reference.

### FIELD OF THE INVENTION

The invention relates to an epicyclic gear stage for a wind turbine gearbox comprising a sun gear, at least two planet gears, engaged with said sun gear, an annulus gear, a first planet carrier flange connected to one side of at least two of said planet gears, a second planet carrier flange connected to the other side of least two of said planet gears, and a wind turbine gearbox, wherein said annulus gear rotates during operation.

### BACKGROUND OF THE INVENTION

One widely used gear for conventional industrial gearboxes is the epicyclic gear.

Various types of this gear have a planet carrier with one or two side flanges. In the case of two side, said flanges are normally connected by stanchions. For some embodiments the input, or drive-end (DE), connecting shaft is linked to either of the flanges and the whole arrangement is typically supported against a stationary frame by bearings on either flange.

The planet bearing may either be mounted on an axle that is supported in the two flanges or the bearings are integrated in the flanges. The design is capable of transferring high torque and to support spur as well as helical gearing.

For a planet carrier design including a two-sided flange and double-helical gears the German DE102004023151 describes a concept where the planets are mounted on their respective axles by a carrier section that is positioned off center relative to the central lateral plane of the planetary gear.

Problems related to the said two-flanged carriers which mark the current state-of-the-art are, that torque on the connecting chaft causes a wind-up of the DE-flange relative to the opposite non-drive end (NDE) flange. The planet axles supported by these flanges are consequently inclined relative to the main axis of rotation, which causes misalignment and eventually edge loading of the gear teeth and planet bearings.

Stanchions between the two flanges are intended to prevent or reduce this wind-up, but their space is constrained by the design envelope of the planet gear. The wind-up can further be reduced by increasing flange thickness, planet carrier outer diameter, planet axle outer diameter or stanchion solidity, each of those adding to material consumption, weight and cost of the component.

The stiff concept of a double-flange carrier can in case of even small manufacturing errors lead to poor load distribution along the tooth width of the gear and between planets.

Furthermore in arrangements where the connecting shaft is not only loaded by torque but also by transverse forces and/or moments and where the bearing suspension on either flange against a stationary frame of the carrier becomes a rigid restraint, the arrangement can not rectify for misalignments.

Alternative planet carrier designs include single one-sided flange with cantilevered planet axles, typically used for lower torques, and single flange planet carrier with spur planet gears arranged on either side of this flange e.g. as presented in WO03014566.

A problem related to single flange planet carriers with cantilevered shafts is that they are not suitable for high loads because bending of the cantilevered planet axle will cause misalignment of the gears.

Another design is the so called “FlexPin” design where the sun pinion and the ring gear are rigid while the planets are mounted to the planet carrier using flexible bolts—the “FlexPins” as will be known for a person skilled in the art.

A problem related to said FlexPin design is that they are not suitable for single-helical gears.

It is an object of the present invention to provide an advantageous construction of an epicyclic gearbox with improved load sharing between gears and to provide a technique without the above mentioned disadvantages.

### SUMMARY OF THE INVENTION

The invention relates to an epicyclic gear stage for a wind turbine gearbox comprising
a sun gear,
at least two planet gears, engaged with said sun gear,
an annulus gear,
a first planet carrier flange connected to one side of at least two of said planet gears, and
a second planet carrier flange connected to the other side of at least two of said planet gears,
wherein torque from the wind turbine rotor is transferred via a torque transfer part connected to at least one of said first and second planet carrier flanges at one or more torque transferring zones,
where said one or more torque transferring zones are located between a first and a second plane, said planes being substantially perpendicular to an axis of rotation of the sun gear,
where the first plane is flush with an inner side of the first planet carrier at a position where the gear shaft is carried by the first planet carrier, and
where the second plane is flush with an inner side of the second planet carrier at a position where the gear shaft is carried by the second planet carrier.

Hereby it is ensured that gear misalignments are reduced and load sharing between gears comprised in said epicyclic gear stage is maintained even.

Furthermore the gear is capable of maintaining gears aligned to the axis of rotation such that an even load distribution along the facewidth of the gear is achieved over a wide torque range and without being affected by transverse forces and moments.

Further it ensures that a well balanced load distribution along gears under essentially any operation is obtained. This will in turn reduce the variance in operating conditions that the gears are exposed to and make the gears more robust.

Even further the variance in the operating conditions of the planet bearings is reduced and hence the robustness of this critical component is increased.

It is also ensured that single components of said eqicyclic gear stage can be replaced without replacing the entire gear stage or wind turbine gear box.

In one aspect of the invention, said a first and a second plane are planes substantially perpendicular to the axis of rotation of the sun gear, and
said first plane is flush with one end of the planet gears, and
said second plane is flush with the other end of the planet gears.

In another aspect of the invention, said a first and a second plane are planes substantial perpendicular to the axis of rotation of the sun gear, and
said first plane comprises a first point of the engaging surface of the planet gears, and
said second plane comprises a second point of the engaging surface of the planet gears.

Hereby it is ensured that said torque transferring zones can positioned in a plane whereby an essential alignment of e.g. the planet axle can be maintained independent of the applied external torque load. Furthermore it is ensured that the alignment of the planet axle is minimally impaired by transverse forces and bending moments acting a torque transfer part e.g. transferring torque from a wind turbine rotor to said epicyclic gear stage.

In a further aspect of the invention, said first planet carrier flange and said second planet carrier flange are joined together at said torque transferring zones such as by casting, welding, joint bolts, rivets etc. Hereby it is ensured that torque transfer between e.g. torque transfer parts and planet axles is done in an axial plane which is shaped such that a controlled deflection and hereby controlled misalignment of the gear contact is achieved.

In an even further aspect of the invention, said one side is the drive end of a gear stage and said other side is the non-drive end of a gear stage.

In another aspect of the invention, said torque transfer part and said first planet carrier flange are formed in one part. Hereby an enhanced torque transfer between the torque transfer part and said first planet carrier flange is achieved which in turn ensures that the alignment of the planet axle is minimally impaired.

In yet another aspect of the invention, said first planet carrier flange and said second planet carrier flange are formed in one part. Hereby an enhanced torque transfer between said first planet carrier flange and said second planet carrier flange is achieved which in turn ensures that the alignment of the planet axle is minimally impaired.

In a further aspect of the invention, said torque transfer part and said first planet carrier flange and said second planet carrier flange are formed in one part. Hereby a maximal degree of torque transfer between the components of said epicyclic gear stage is achieved which in turn ensures that the alignment of the planet axle is minimally impaired.

In an even further aspect of the invention, said torque transferring zones are located substantially at the midpoint of the distance between inner sides of first and second planet carriers. Hereby it is ensured that torque transfer between e.g. torque transfer parts and planet axles is done in the axial plane where the alignment of the planet axle is minimally impaired which in turn increases the robustness of this critical component.

In another aspect of the invention, said torque transferring zones are located at an offset from the middle point of the midpoint of the distance between inner sides of first and second planet carriers. Hereby it is possible to achieve a controlled gear misalignment e.g. in the order of magnitude of the sun pinion torsion.

In a further aspect of the invention, said offset is in the range of 0 to 50% of the distance between inner sides of first and second planet carriers, preferable in the range of 5 to 20%.

In another aspect of the invention, said sun gear and said planet gear and said annulus gear are single helical gears. Hereby an advantageous gear regarding smooth gear contact, reduction of vibration and load variation, as well as emission of noise is ensured.

In another aspect of the invention, said torque transfer part is connected to said least one of said first and second planet carrier flanges at one or more torque transferring zones by one or more couplings such as protrusions, cones, bolts etc. Hereby it is ensured that load sharing between the planet gears i.e. isolation of transverse loads is improved and that dampening that prevents transmission of structure-bone noise via the torque transfer part is achieved e.g. for reducing the excitation of a wind turbine rotor blade by gear frequencies. Furthermore an easy assembling of the gear stage is achieved.

In yet another aspect of the invention, said annulus gear rotates during operation. Hereby it is ensured that torque is transferred for various types of gear stages e.g. with a fixed carrier, in which case torque transfer part 25 is part of the housing, or with a rotating carrier as part of a 3-way epicyclic gear.

The invention also relates to a wind turbine gearbox comprising one or more epicyclic gear stages according to claims 1 to 14, whereby an advantageous wind turbine gearbox is obtained.

Furthermore the invention relates to a wind turbine comprising a wind turbine gearbox according to claim 15.

### BRIEF DESCRIPTION OF THE DRAWINGS

The invention will be described in the following with reference to the figures in which

FIG. 1 illustrates a large modern wind turbine including three wind turbine blades in the wind turbine rotor,

FIG. 2 illustrates schematically an embodiment of a wind turbine nacelle as seen from the side,

FIG. 3 illustrates schematically as an example of prior art, an embodiment of an epicyclic gearbox as seen from the front,

FIG. 4 illustrates schematically as an example of prior art, an embodiment of an epicyclic gearbox comprising a planet carrier as seen from the front,

FIG. 5 illustrates schematically as an example of prior art, a part of a cross section of one embodiment of an epicyclic gearbox as seen from the side,

FIG. 6 illustrates schematically a part of a cross section of a first embodiment of the invented epicyclic gearbox as seen from the side,

FIG. 7 illustrates schematically a part of a cross section of a second embodiment of the invention as seen from the side,

FIG. 8 illustrates schematically a part of a cross section of a third embodiment of the invention as seen from the side,

FIG. 9 illustrates schematically a part of a cross section of another embodiment of the invention comprising a protrusion in carrier flange to transmit torque,

FIG. 10 illustrates schematically a part of a cross section of another embodiment of the invention comprising a cone in the carrier flange to transmit torque,

FIG. 11 illustrates schematically a part of a cross section of yet another embodiment of the invention comprising bolts to connect torque transfer parts and carrier flanges,

### DETAILED DESCRIPTION OF THE INVENTION

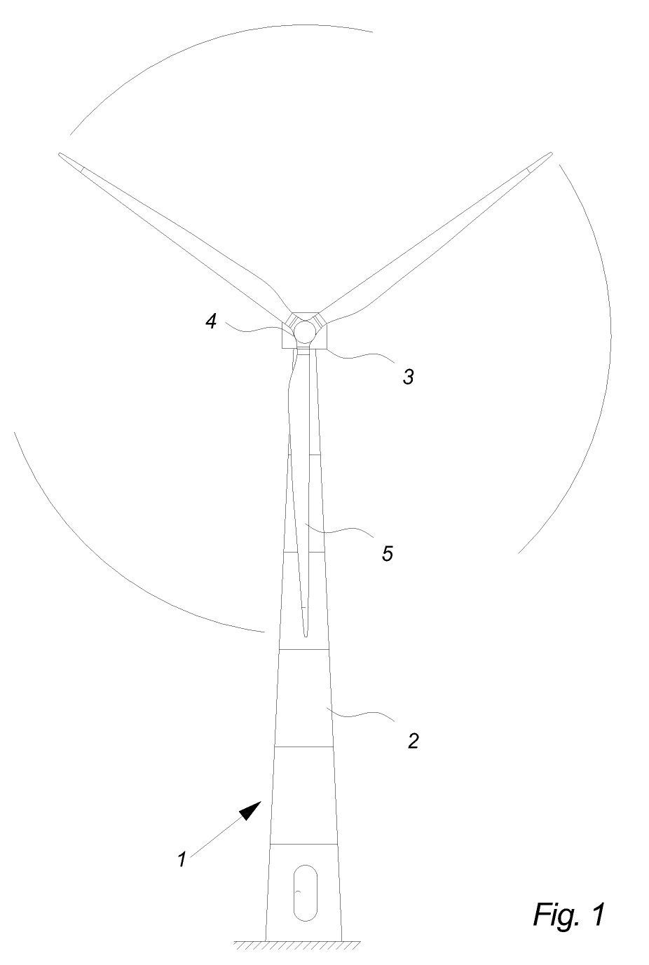

FIG. 1 illustrates a modern wind turbine 1, comprising a tower 2 and a wind turbine nacelle 3 positioned on top of the tower 2. The wind turbine rotor 4, comprising three wind turbine blades 5, is connected to the nacelle 3 through the low speed shaft 6 which extends out of the nacelle 3 front.

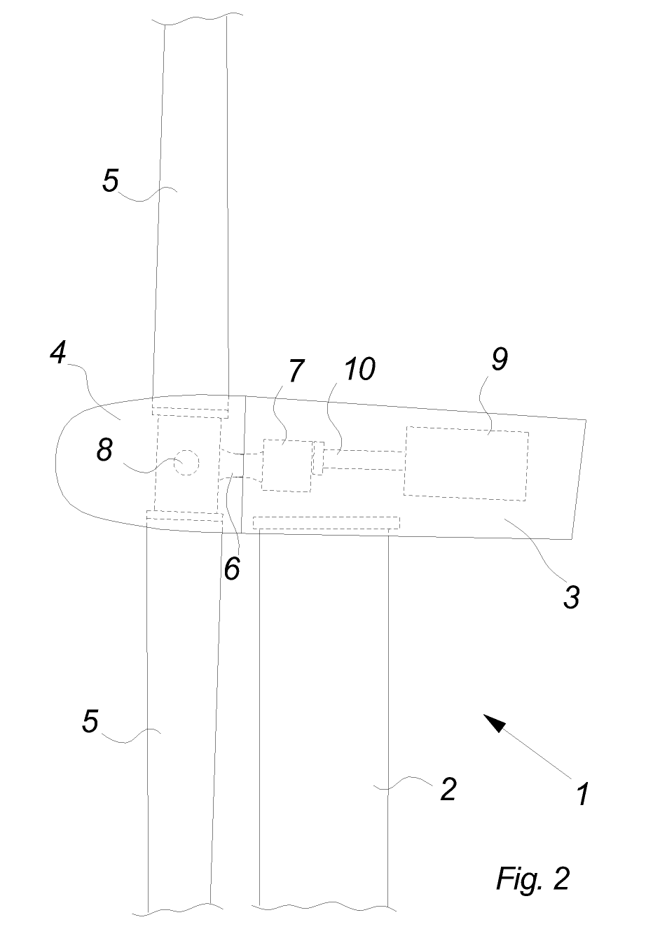

FIG. 2 illustrates an embodiment of a wind turbine nacelle 3, as seen from the side. The drive train in a traditional wind turbine 1 known in the art usually comprises a rotor 4 connected to a gearbox 7 by means of a low speed shaft 6. In this embodiment the rotor 4 comprise only two blades 5 connected to the low speed shaft 6 by means of a teeter mechanism 8, but in another embodiment the rotor 4 could comprise another number of blades 5, such as three blades 5, which is the most common number of blades 5 on modern wind turbines 1. In another embodiment the rotor 4 could also be connected directly to the gearbox 7.

The gearbox 7 is then connected to the generator 9 by means of a high speed shaft 10.

Because of the limited space in the nacelle 3 and to minimize the weight of the nacelle 3 the preferred gearbox 7 type in most modern wind turbines 1 is an epicyclic gearbox, but other gearbox 7 types are also feasible, such as one or more spur gearboxes, worm gearboxes, helical gearboxes or a combination of different transmission and gearbox 7 types.

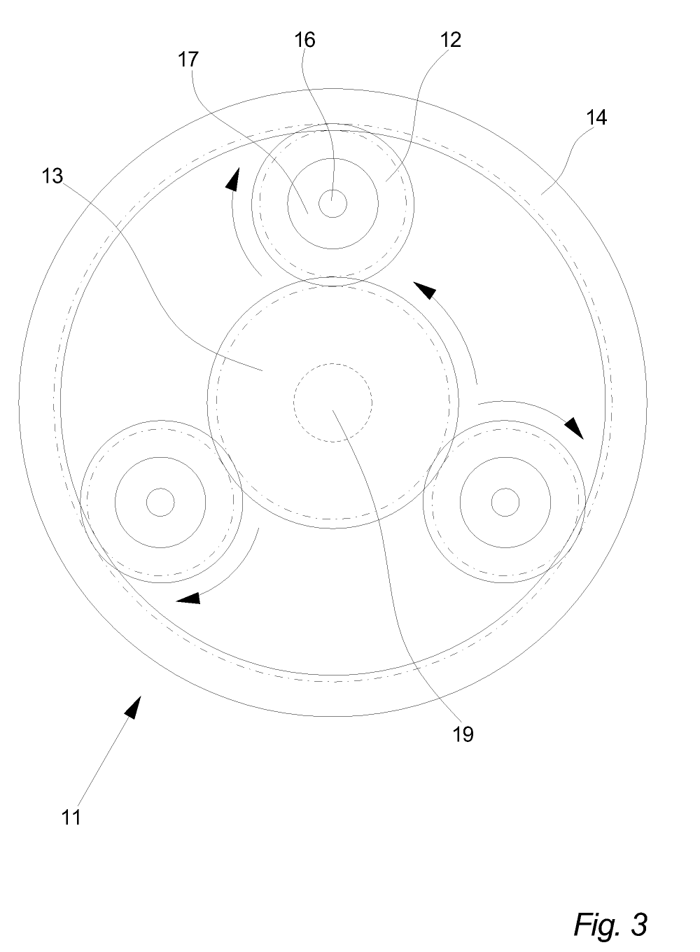

FIG. 3 illustrates as an example of prior art, an embodiment of an epicyclic gear stage 11 as seen from the front. The planet gears 12 mesh with and rotate around a sun gear 13 in the middle and they mesh with an outer annulus gear 14. The arrows indicate that the planet gears 12 all rotate in the same direction and that the sun gear 13 rotates in the opposite direction.

In this embodiment the epicyclic gear stage 11 comprise three planet gears 12, but in another embodiment it could also comprise another other number greater than or equal to 2 planet gears 12.

Each planet gear 12 is provided with one or more planet gear bearings 17 and each of the planet gears 12 with bearings 17 are mounted on a planet gear shaft 16.

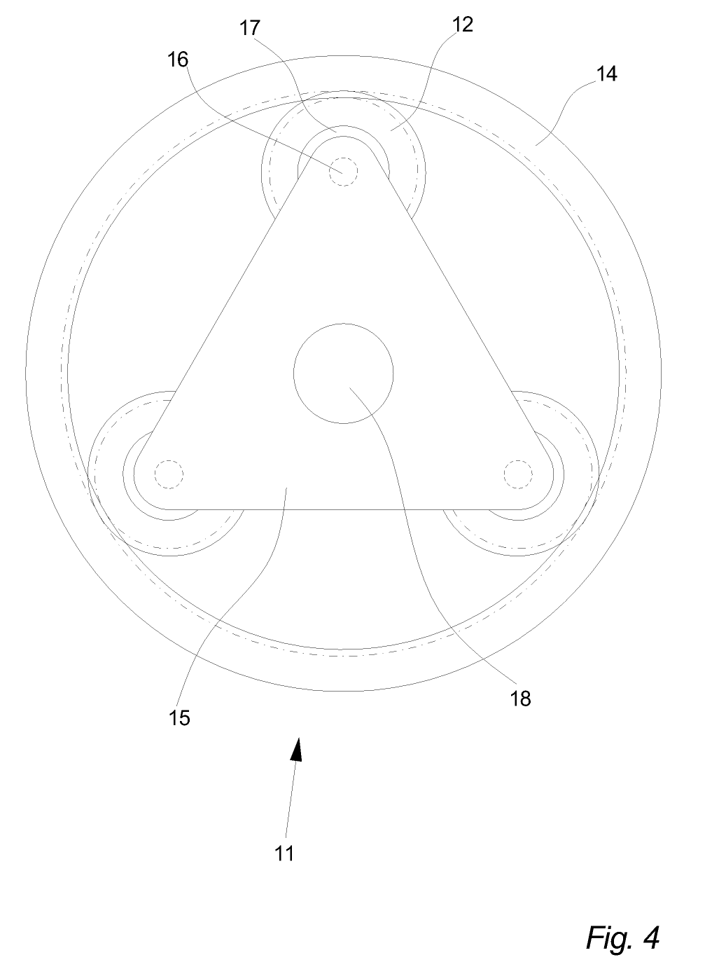

FIG. 4 illustrates as an example of prior art, an embodiment of an epicyclic gear stage 11 comprising a planet carrier 15, as seen from the front. The planet carrier 15 connects the planet gears 12 by fixating the planet gear shafts 16, making it rotate as the planet gears 12 travels around the sun gear.

Typically the annulus gear 14 is connected to a carrying frame, to the gearbox housing or is in other ways fixed, but in some epicyclic gearbox 11 types the annulus gear 14 could also rotate. Furthermore, the illustrated gears show only one stage of a gearbox. The entire gearbox could comprise a number of stages as the one shown to increase the gearing, or it could comprise a number of different stages e.g. a first stage where the sun gear is missing and the input shaft 18 rotates the annulus gear 14, which mesh with a number of planet gears 12. The planet gears 12 of the first stages is then connected to planet gears 12 of a larger size in a second stage, which mesh with a sun gear 13, which is connected to the output shaft of the epicyclic gear stage 11.

Other gearbox designs are also feasible often depending on what the gearbox is to be used for. In wind turbines the gearbox 11 may be designed to carry the entire torque load of the rotor, which means that the gearbox 11 has to be designed to handle this massive torque load on the input side of the gearbox 11, whereas the torque load on the output side of the gearbox would be significantly smaller. Epicyclic gearboxes 11 used in different wind turbines 1 or gearboxes 11 used in other applications could therefore be designed differently to meet different needs.

In this embodiment of an embodiment of an epicyclic gear stage 11, the planet carrier 15 is formed as a one piece plate connecting the three planet gears 12, but in another embodiment the planet carrier 15 could further comprise one or more bearings for guiding and stabilizing the carrier 15. This would e.g. be the case if the carrier 15 was connected to a wind turbine rotor, and the planet carrier 15 also had to transfer the entire load of the rotor. The inner ring of a large diameter bearing could then e.g. be mounted on the outside of the annulus gear 14 and the outer ring of the bearing could be connected to the planet carrier 15, which then would extend beyond the annulus gear 14, or a more or less circular planet carrier 15 could be provided with a bearing around its outer perimeter, where the outer ring of the bearing was connected to the annulus gear 14, the gearbox housing 20 or in other ways fixed.

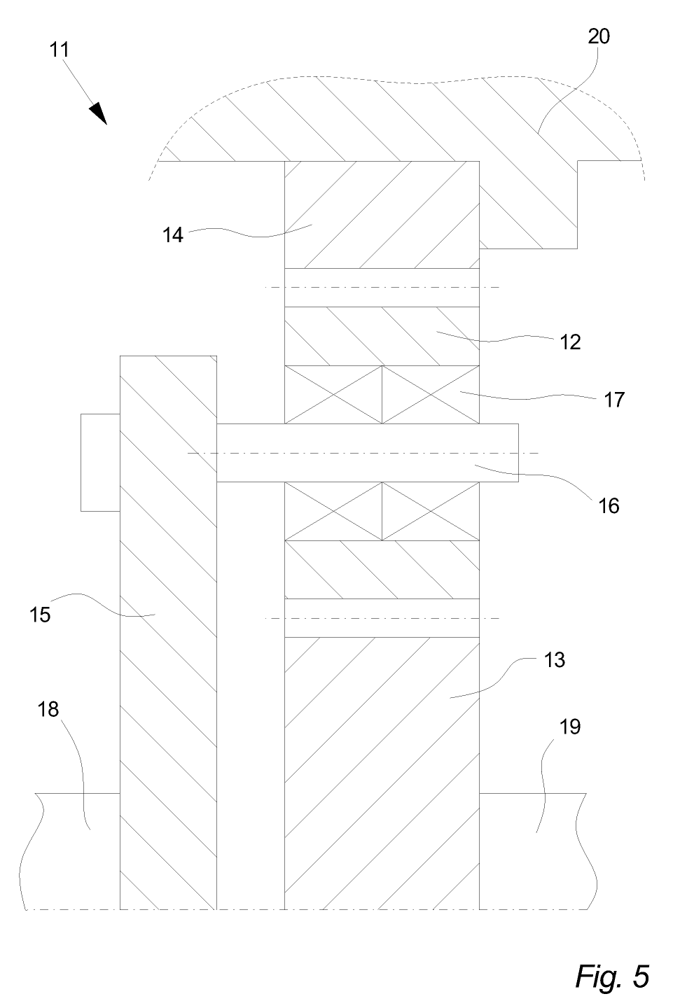

FIG. 5 illustrates as an example of prior art, a part of a cross section of an embodiment of an epicyclic gear stage 11 with a single flange carrier, as seen from the side. In this embodiment of an epicyclic gear stage 11 the planet gears 12 are each provided with two juxtaposed bearings 17 but in another embodiment the planet gears 12 could be provided with another number of bearings 17 or the bearings 17 could be placed in the planet carrier 15, where the shaft 16 then would be rigidly connected to the planet gears 12.

The planet carrier 15 is provided with an input shaft 18, which could be the low speed shaft of a wind turbine, but in another embodiment the carrier 15 could be directly coupled to the input generating equipment such as the hub of a wind turbine rotor.

The planet gears 12 mesh with the annulus gear 14, which in this embodiment is rigidly connected to the gearbox housing 20, and with the sun gear 13, which is provided with an output shaft 19 e.g. connected to another gear stage or connected to a wind turbine generator.

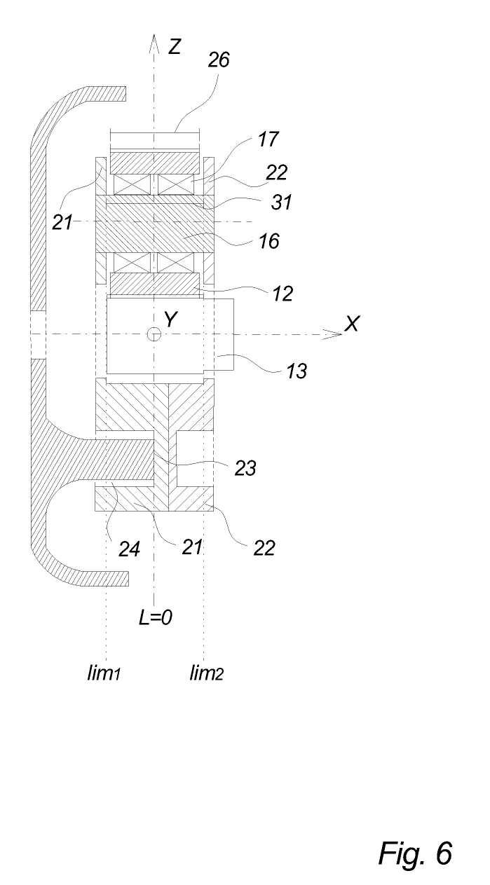

FIG. 6 illustrates schematically a part of a cross section of a first embodiment of the invented epicyclic gear stage as seen from the side. In this embodiment the planet gears 12 are supported by planet gear bearings 17 and planet gear shaft 16. The planet gear shaft 16 is supported between two planet carrier flanges 21, 22. Torque from the rotor is transferred to the planet carrier flanges 21, 22 by a torque transfer part 25 which is connected to one or both of said flanges 21, 22 at torque transferring zones 23. The torque transfer part 25 and the first and second planet carrier flanges 21, 22 are formed in such a way that there is a free space 24 between said flanges 21, 22 and the torque transfer part 25 except substantially at the torque transferring zones 23.

According to the present invention the torque transferring zones 23 are located between a first and second plane, said planes being substantially perpendicular to an axis of rotation of the sun gear 13, where the first plane is flush with an inner side of the first planet carrier 21 at a position where the gear shaft 16 is carried by the first planet carrier 21, and where the second plane is flush with an inner side of the second planet carrier 22 at a position where the gear shaft 16 is carried by the second planet carrier 22.

On FIG. 6 said first and second planes are, according to this embodiment of the invention, indicated by dotted lines denoted lim1 and lim2.

Furthermore according to the embodiment depicted in FIG. 6, said torque transferring zones 23 are located at a neutral plane defined as to be a plane substantial perpendicular to the axis of rotation of the sun gear 13 and substantially at the midpoint of the distance between inner sides of first and second planet carriers 31 (L=0).

The said torque transfer part 25 is for various embodiments of the invention a part of the low speed shaft of a wind turbine, but in other embodiments the torque transfer part 25 is directly coupled to the input generating equipment such as the hub of a wind turbine rotor.

The planet gears 12 mesh with the annulus gear, which for various embodiments of the invention is rigidly connected the gearbox housing. Furthermore the planet gears 12 mesh with the sun gear 13, which is provided with an output shaft e.g. connected to another gear stage or connected to a wind turbine generator.

Some contour lines depicted in FIG. 6 are left out in the following figures.

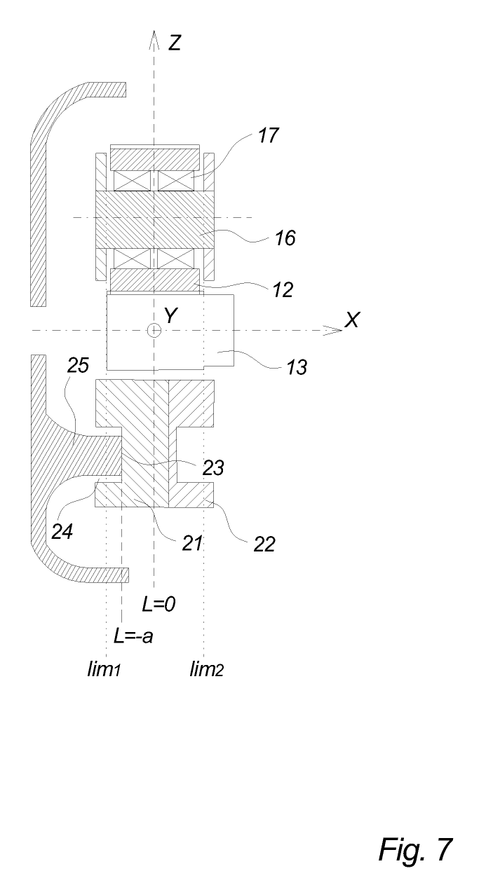

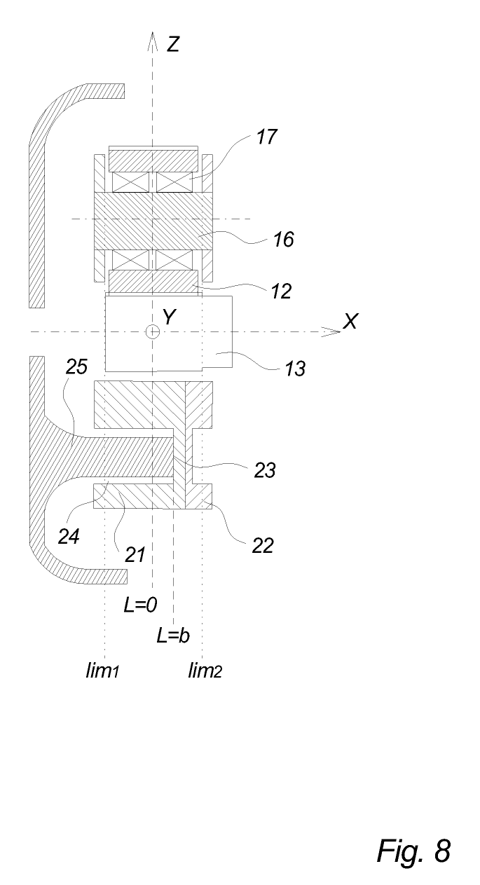

FIGS. 7 and 8 illustrates schematically a part of a cross section of a second and third embodiment of the invented epicyclic gear stage 11 as seen from the side. In these embodiments the torque transferring zones 23 are dislocated from the neutral plane as defined in the explanation of FIG. 6.

FIG. 7 illustrates an embodiment where the said dislocation is oriented in the negative X-axis direction i.e. at L=−a, and FIG. 8 illustrates an embodiment where the said dislocation is oriented in the positive X-axis direction i.e. at L=b.

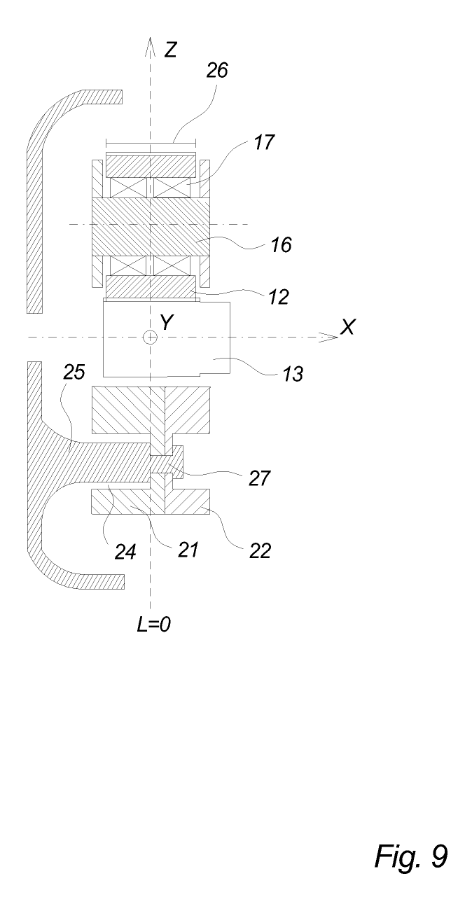

FIG. 9 illustrates schematically a part of a cross section of another embodiment of the invention comprising a protrusion 27 in carrier flange to transmit torque. The protrusion 27 may for various embodiments vary in dimensions as to adapt to the dimensions of carrier flanges 21, 22, the through holes in the carrier flanges 21, 22, the torque and forces that it may be exposed to etc.

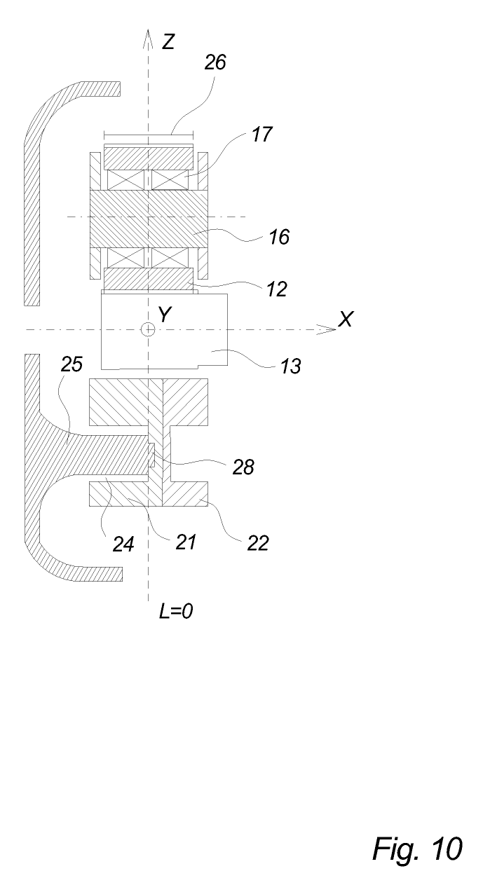

FIG. 10 illustrates schematically a part of a cross section of another embodiment of the invention comprising a cone 28 in the carrier flange to transmit torque. The cone 28 may for various embodiments vary in dimensions and in form as to adapt to the carrier flanges 21, 22 and to the torque and forces that it may be exposed to and the like.

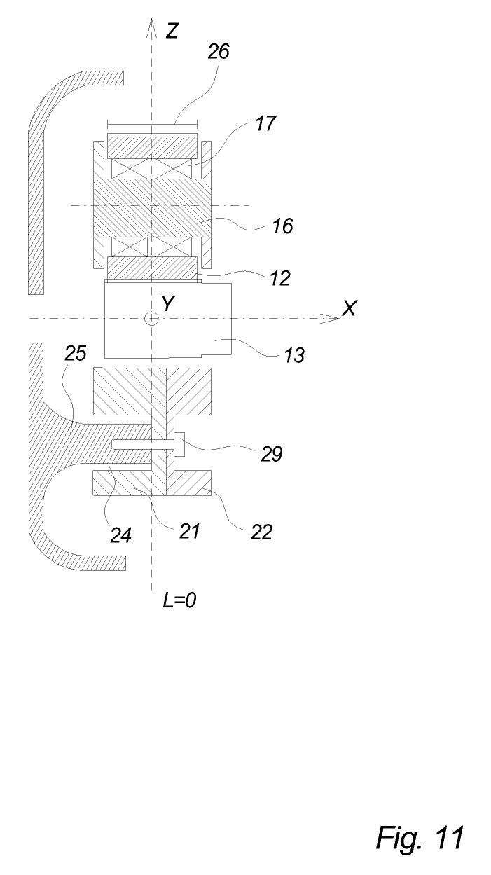

FIG. 11 illustrates schematically a part of a cross section of yet another embodiment of the invention comprising bolts 29 to connect torque transfer parts and carrier flanges. The bolts 29 may for various embodiments vary in dimensions as to adapt to the dimensions of carrier flanges 21, 22, the through holes in the carrier flanges 21, 22, the torque and forces that it may be exposed to etc. Furthermore the material of which the bolts 29 are made of may be of specific alloys that enables the bolts to carry high torques and forces.

For various embodiments of the invention, the torque transfer part 25 and said first planet carrier flange 21 are formed in one part.

For other embodiments of the invention, the first and second planet carrier flanges 21, 22 are formed in one part.

For even further embodiments of the invention, the torque transfer part 25, the first planet carrier flange 21 and the second planet carrier flange 22 are formed in one part.

For various embodiments of the invention, each of the torque transfer part 25, the first planet carrier flange 21 and the second planet carrier flange 22 may be formed in two or more parts.

What is claimed is:

1. An epicyclic gear stage for a wind turbine gearbox comprising
a sun gear,
at least two planet gears, engaged with said sun gear,
an annulus gear,
a first planet carrier flange connected to one side of at least two of said planet gears, and
a second planet carrier flange connected to the other side of at least two of said planet gears,
wherein a torque from the wind turbine rotor is transferred via a torque transfer part connected to at least one of said first and second planet carrier flanges at one or more torque transferring zones,
where said one or more torque transferring zones are located between a first and a second plane, said planes being substantially perpendicular to an axis of rotation of the sun gear,
where the first plane is flush with an inner side of the first planet carrier at a position where the gear shaft is carried by the first planet carrier, and
where the second plane is flush with an inner side of the second planet carrier at a position where the gear shaft is carried by the second planet carrier.

2. The epicyclic gear stage according to claim 1, wherein said a first and a second plane are planes substantially perpendicular to the axis of rotation of the sun gear, and
where said first plane is flush with one end of the planet gears, and
where said second plane is flush with the other end of the planet gears.

3. The eqicyclic gear stage according to claim 1, wherein said a first and a second plane are planes substantial perpendicular to the axis of rotation of the sun gear, and
where said first plane comprises a first point of the engaging surface of the planet gears, and
where said second plane comprises a second point of the engaging surface of the planet gears.

4. The epicyclic gear stage according to claim 1, wherein said first planet carrier flange and said second planet carrier flange are joined together at said torque transferring zones.

5. The epicyclic gear stage according to claim 1, wherein said one side is the drive end of a gear stage and said other side is the non-drive end of a gear stage.

6. The epicyclic gear stage according to claim 1, wherein said torque transfer part and said first planet carrier flange are formed in one part.

7. The epicyclic gear stage according to claim 1, wherein said first planet carrier flange and said second planet carrier flange are formed in one part.

8. The epicyclic gear stage according to claim 1, wherein said torque transfer part and said first planet carrier flange and said second planet carrier flange are formed in one part.

9. The epicyclic gear stage according to claim 1, wherein said torque transferring zones are located substantially at the midpoint of the distance between inner sides of first and second planet carriers.

10. The epicyclic gear stage according to claim 1, wherein said torque transferring zones are located at an offset from the middle point of the midpoint of a distance between inner sides of first and second planet carriers.

11. The epicyclic gear stage according to claim 10, wherein said offset is in the range of 0 to 50% of the distance between inner sides of first and second planet carriers.

12. The epicyclic gear stage according to claim 1, wherein said sun gear and said planet gear and said annulus gear are single helical gears.

13. The epicyclic gear stage according to claim 1, wherein said torque transfer part is connected to said at least one of said first and second planet carrier flanges at one or more torque transferring zones by one or more couplings.

14. The epicyclic gear stage according to claim 1, wherein said annulus gear rotates during operation.

15. A wind turbine gearbox comprising one or more epicyclic gear stages according to claim 1.

16. A wind turbine comprising a wind turbine gearbox according to claim 15.
